(19) United States
(12) Patent Application Publication
(10) Pub. No.: US 2006/0158971 A1
(43) Pub. Date: Jul. 20, 2006

(54) Objective lens for optical disk recording/reproducing device comprising variable lens formed by the interface of two immiscible fluids

(76) Inventors: Bernardus Hendrikus Wilhelmus Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,396

(22) PCT Filed: Feb. 19, 2004
(86) PCT No.: PCT/IB04/50134

§ 371 Date: Aug. 18, 2005

(30) Foreign Application Priority Data
Feb. 25, 2003 (EP) 03075556.5
May 14, 2003 (EP) 03101349.3

(51) Int. Cl. G11B 7/00

(52) U.S. Cl. 369/44.23; 369/112.23

(57) ABSTRACT

There is disclosed an objective lens (16),for use with optically readable disks of differing cover layer thicknesses, wich objective lens (16) comprises a variable lens (1) formed by the interface between two immiscible fluids (A, B), which variable lens (1) can be in one of at least two discrete states and whereby the focus point of the objective lens (16) varies between the two states of the variable lens (1).

### FIELD OF THE INVENTION

The present invention relates to objective lenses. The present invention also relates to optical devices, optical scanning devices and optical disk recording/reproducing apparatus incorporating such objective lenses.

### BACKGROUND OF THE INVENTION

Two element Blu-ray Disk (BD) (previously referred to as Digital Video Recorder (DVR)) objective lenses having a numerical aperture of NA=0.85, operating at a wavelength of 405 nm, for optical disks having a cover layer thickness of 0.1 mm are characterised by the fact that the free working distance between the exit surface of an objective lens and the entrance surface of the disk (the cover layer) is relatively small, typically less than 0.3 mm. A typical BD has a cover layer 0.1 mm thick, which is the distance between the entrance layer of the disk and the optically readable surface thereof. When using such an objective lens to focus on a Digital Versatile Disk (DVD) having a cover layer of 0.6 mm, it is clear that the available free working distance becomes too small. It is, therefore, problematical to make a BD objective lens compatible with a DVD system.

It is known from WO 03/069380 to provide a variable focus lens comprising a first fluid and a second, non-miscible, fluid in contact over a meniscus. A first electrode separated from the fluid bodies by a fluid contact layer, and a second electrode in contact with the first fluid to cause an electrowetting effect, whereby the shape of the meniscus is altered. Such a variable focus lens can be used in an optical scanning device (see FIG. 5 of WO 03/069380) containing such an electrowetting lens to enable recording and/or playback from a dual layer DVR disk. In FIG. 5 of WO 03/069380 lenses 202, 204 form the objective lens that is mounted on an actuator moving in two perpendicular planes. The electrowetting lens 200 is not part of the objective lens. The focal length of the objective lens of FIG. 5 is fixed and the electrowetting lens 200 cannot be used to accommodate substantial differences in optical carrier thickness (from an entrance layer to a readable layer). In the FIG. 5 embodiment of WO 03/069380 the variation in focus only needs to be 0.02 mm which is insufficient to cope with different cover layer thicknesses.

It is, therefore, an aim of preferred embodiments of the present invention to provide an objective lens suitable for use with optically readable disks of differing cover layer thicknesses.

It is also an aim of preferred embodiments of the present invention to provide an optical device, an optical scanning device and an optical disk recording/reproducing apparatus with an improved objective lens.

### SUMMARY OF THE INVENTION

According to the present invention in a first aspect, there is provided an objective lens, which objective lens comprises a variable lens formed by the interface of two immiscible fluids, which variable lens can be in one of at least two different states and whereby the focus point of the objective lens varies between the two states of the variable lens.

The use of such a variable lens in an objective lens means that a change of focal length of the objective lens can be achieved without the need for moving parts and with substantial ease of manufacture.

Suitably, the focus point varies by at least 0.1 mm, typically by at least 0.25 mm and preferably at least 0.45 mm. A suitable focus point variation is 0.5 mm. This is suitable for use with Blu-ray disks (BDs) and DVDs.

Suitably, in the first state of the variable lens the objective lens is configured for use with a disk having a first cover layer thickness and in the second state the objective lens is configured for use with a disk having a different cover layer thickness.

Suitably, the objective lens is configured whereby a change in state of the variable lens between a configuration for a first disk of a first cover layer thickness and a second disk of a second cover layer thickness compensates for the introduction of spherical aberration introduced by differences between the first and second disks. The ability to compensate for spherical aberration is another advantage of this objective lens.

Suitably, the objective lens is suitable for a combined BD and DVD system. The objective lens finds particular advantage for a combined BD and DVD system, accommodating the different requirements for free working distance.

Suitably, the variable lens comprises first and second fluids, and the first and second fluids are of substantially identical specific gravity. In this manner an interface free from gravitational variations is provided.

Suitably, a first fluid comprises a substantially non-conductive fluid, further referred to as an oil, whilst a second fluid comprises a substantially conducting and/or polar fluid, further referred to as an electrolyte.

Suitably, a second fluid comprises a water/salt mixture having a refractive index different to the refractive index of a first fluid.

Suitably, the objective lens comprises a first lens and a second lens, in which the first lens precedes the second lens in an optical path from a light source to a disk. Suitably the first lens is a converging lens.

Suitably, the objective lens further comprises a movable stop to change the aperture size of the objective lens between the two states of the variable lens.

Suitably, the objective lens comprises a two lens objective lens.

Suitably, the variable lens comprises an electrowetting lens.

Suitably, the electrowetting lens comprises a transparent first element, a transparent second element, a cavity formed between the transparent first element and the transparent second element, first and second immiscible fluids of differing refractive index contained within the cavity, and electrodes to which a potential difference can be applied to change a contact angle between an interface layer of the two fluids and a wall of the cavity.

Suitably, the first wall comprises a first lens of the objective lens. Suitably, the second wall is spaced from a second lens. Thus, a compact objective lens can be produced.

According to the present invention in a second aspect, there is provided an optical device comprising an objective lens according to the first aspect of the present invention.

According to the present invention in a third aspect, there is provided an optical scanning device for scanning an optical disk, the optical scanning device comprising an objective lens according to the first aspect of the present invention.

According to the present invention in a fourth aspect, there is provided an optical disk reproducing/recording apparatus comprising an objective lens according to the first aspect of the present invention.

Thus there can be two read-out modes of different numerical apertures. Suitably, the apparatus has DVD and BD modes and further comprises a controller for switching between the DVD and BD modes, whereby in the DVD mode the variable lens is in a first state for a DVD and in the BD mode the variable lens is in a second state for a BD disk.

### BRIEF DESCRIPTION OF THE DRAWINGS

The present invention will now be described, by way of example only, with reference to the drawings that follow; in which:

FIG. 1 is a schematic cross-sectional elevation of a known electrowetting lens in a first state.

FIG. 2 is a schematic cross-sectional elevation of the lens of FIG. 1 in a second state.

FIG. 3 is a schematic view of an objective lens according to the present invention configured for use with a first disk, such as a BD.

FIG. 4 is a schematic view of an objective lens according to the present invention configured for use with a second disk, such as a DVD.

FIG. 5 is a schematic illustration of a DVD/BD player/recorder according to the present invention.

FIG. 6 is a schematic illustration of an optical path for use in the DVD/BD player/recorder of FIG. 5.

### DESCRIPTION OF THE PREFERRED EMBODIMENTS

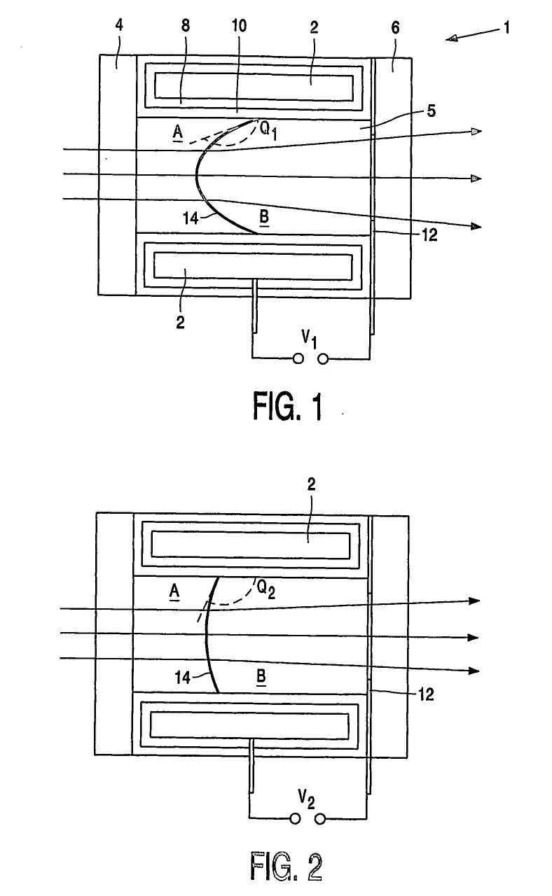

With reference to FIGS. 1 and 2 of the drawings that follow, there is shown a variable lens 1 of the type described in WO 03/069380 in which the lens is formed by the interface of two immiscible fluids, in this case an electrowetting lens. The electrowetting lens 1 comprises a cylindrical first electrode 2 forming a capillary tube, sealed by means of a transparent front element 4 and a transparent back element 6 to form a fluid chamber cavity 5 containing two fluids. The electrode 2 may be a conducting coating applied on the inner wall of a tube. In this embodiment the two fluids consist of two non-miscible liquids in the form of an electrically insulating first liquid A, such as a silicone oil or an alkane, referred to herein further as “the oil”, and an electrically conducting second liquid B, such as water containing a salt solution. The two liquids are preferably arranged to have an equal density, so that the lens functions independently of orientation, i.e. without dependence on gravitational effects between the two liquids. This may be achieved by appropriate selection of the first liquid constituent; for example alkanes or silicon oils may be modified by addition of molecular constituents to increase their density to match that of the salt solution.

Depending on the choice of the oil used, the refractive index of the oil may vary between 1.25 and 1.70. Likewise, depending on the amount of salt added, the salt solution may vary in refractive index between 1.30 and 1.48. The fluids in this embodiment are selected such that the first fluid A has a higher refractive index than the second fluid B. The first electrode 2 is a cylinder of inner radius typically between 1 mm and 20 mm. The electrode 2 is formed from a metallic material and is coated by an insulating layer 8, formed for example of parylene. The insulating layer has a thickness of between 50 nm and 100 nm, with typical values between 1 μm and 10 μm. The insulating layer is coated with a fluid contact layer 10, which reduces the hysteresis in the contact angle of the meniscus with the cylindrical wall of the fluid chamber. The fluid contact layer is preferably formed from an amorphous fluorocarbon such as Teflon™ AF1600 produced by DuPont™.

The fluid contact layer 10 has a thickness of between 5 nm and 50 μm. The AF1600 coating may be produced by successive dip coating of the electrode 2, which forms a homogeneous layer of material of substantially uniform thickness since the cylindrical sides of the electrode are substantially parallel to the cylindrical electrode; dip coating is performed by dipping the electrode whilst moving the electrode in and out of the dipping solution along its axial direction. The parylene coating may be applied using chemical vapour deposition. The wettability of the fluid contact layer by the second fluid is substantially equal on both sides of the intersection of the meniscus 14 with the fluid contact layer 10 when no voltage is applied between the first and second electrodes.

It is also possible to use the AF1600 fluid contact layer as the insulating layer, since it has insulating properties. The use of parylene is not necessary.

A second, annular electrode 12 is arranged at one end of the fluid chamber, in this case, adjacent the back element. The second electrode 12 is arranged with at least one part in the fluid chamber such that the electrode acts on the second fluid B.

The two fluids A and B are non-miscible so as to tend to separate into two fluid bodies separated by a meniscus 14. When no voltage is applied between the first and second electrodes, the fluid contact layer has a higher wettability with respect to the first fluid A than the second fluid B. Due to electrowetting, the wettability by the second fluid B varies under the application of a voltage between the first electrode and the second electrode, which tends to change the contact angle of the meniscus at the three phase line (the line of contact between the fluid contact layer 10 and the two liquids A and B). The shape of the meniscus is thus variable in dependence on the applied voltage.

Referring now to FIG. 1, when a low voltage V1, e.g. between 0 V and 20 V, is applied between the electrodes the meniscus adopts a first concave meniscus shape. In this configuration, the initial contact angle Q₁ between the meniscus and the fluid contact layer 10, measured in the fluid B is for example approximately 140″. Due to the higher refractive index of the first fluid A than the second fluid B, the lens formed by the meniscus, here called meniscus lens, has a relatively high negative power in this configuration. To reduce the concavity of the meniscus shape, a higher magnitude of voltage is applied between the first and second electrodes. Referring now to FIG. 2, when an intermediate voltage V2, e.g. between 20 V and 150 V, depending on the thickness of the insulating layer, is applied between the electrodes the meniscus adopts a second concave meniscus shape having a radius of curvature increased in comparison with the meniscus in FIG. 1. In this configuration, the intermediate contact angle Q₂ between the first fluid A and the fluid contact layer 10 is for example approximately 100″. Due to the higher refractive index of the first fluid A than the second fluid B the meniscus lens in this configuration has a relatively low negative power.

Note furthermore that the initial, low voltage, configuration will vary in dependence on the selection of the liquids A and B, in dependence on their surface tensions). By selecting an oil with a higher surface tension, and/or by adding a component, such as ethylene glycol, to the salt solution which reduces its surface tension, the initial contact angle can be decreased. In any case, the low power configuration remains such that the meniscus is concave, and a relatively wide range of lens powers can be produced without using an excessive voltage.

Although the fluid A has a higher refractive index than fluid B in the above example, the fluid A may also have a lower refractive index than fluid B. For example, the fluid A may be a (per)fluorinated oil, which has a lower refractive index than water. In this case the amorphous fluoropolymer layer is preferably not used, because it might dissolve in fluorinated oils. An alternative fluid contact layer is e.g. a paraffin coating.

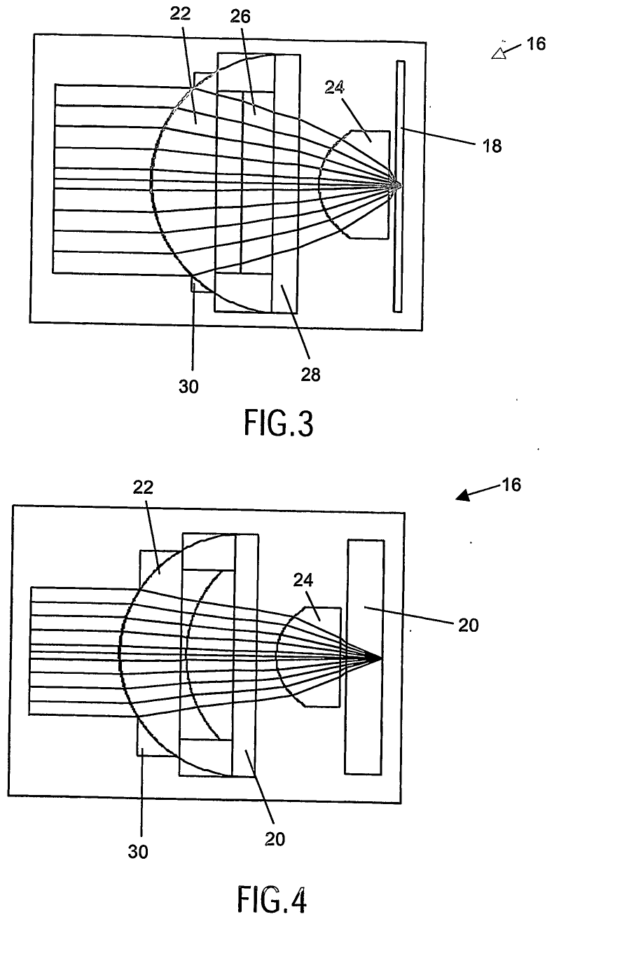

With reference to FIGS. 3 and 4 of the drawings that follow, there is shown a two element objective lens 16 according to the present invention. In FIG. 3 the objective lens is being used with an optical disk 18 having a first cover layer thickness, such as a BD and in FIG. 2 with an optical disk 20 of a second cover layer thickness, such as a DVD. Both disks 18, 20 are optical record carriers in the sense of carrying or being capable of carrying data that can be read optically. The objective lens 16 comprises a first lens 22 and a second plastics lens 24 spaced therefrom. The first lens 22 comprises a glass-photopolymer lens and is followed by a two-fluid component layer forming an electrowetting lens 26 which is sealed off with a FK5 glass plate 28. The electrowetting lens 26 is shown in FIGS. 3 and 4 without some of the detail of FIGS. 1 and 2 for clarity. The electrowetting lens 26 lies in the optical path between the first lens 22 and the second lens 24. The second lens 24 is made of plastics cyclo-olefin copolymer (COC). A movable stop element 30 is provided over the first lens 22. Instead of a movable stop, a dichroic filter can be used to select different stop sizes for the different readout modes having readout beams with different wavelengths. Furthermore, applying two stops at different positions as described in U.S. Pat. No. 6,278,560 can be applied.

The objective lens of FIG. 3 and 4 will now be described in more detail. The objective lens has during scanning of BD a numerical aperture of NA=0.85, an entrance pupil diameter of 3 mm and wavelength of 405 nm. For the DVD readout the entrance pupil diameter is 2.18 mm, the NA=0.6 and the wavelength is 650 nm. Lens elements 22 consist of a truncated sphere of Schott FK5 glass with thickness 1 mm along the optical axis. The radius of the sphere is 2.07 mm. On top of this sphere a thin aspheric acrylic layer having a thickness of 0.019 mm along the optical axis. The rotational symmetric shape of this acrylic layer is given by

$$z ( r ) = {\sum }_{i = 1}^{8} {B}_{2 i} {r}^{2 i} \qquad ( 1 )$$

where z is the position of the surface in the direction of the optical axis in millimetres, r the distance from the optical axis in millimetres, and Bₖ the coefficient of the k-th power of r. In this embodiment the value of the coefficients B₂ to B₁₆ are 0.26447094, 0.0088460392, 0.00014902273, 0.0014305415, −0.0015440542, 0.00082680417, −0.00023319199 and 2.5911741e-005, respectively. The thickness of the chamber containing the fluids is 0.9 mm. The chamber is closed by a glass plate 28 made of FK5 Schott glass of 0.4 mm thickness. The distance along the optical axis between the first and second lens of the objective is 0.332 mm. The second lens 24 is a plano-aspheric lens with thickness of 1.09 mm. The rotational symmetric aspheric shape of this layer is again given by equation (1) but now with the coefficients B₂ to B₁₆ given by 0.54345409, 0.12859997, 0.61212921, −4.2125496, 18.163849, −42.836368, 53.165871 and −27.014846, respectively. The refractive index of the acrylic layer, FK5 and COC at 405 nm (hence BD readout) are 1.599, 1.499 and 1.550, respectively, while at 650 nm (hence DVD readout they are given by 1.565, 1.486 and 1.531, respectively.

Referring again now to FIGS. 3 and 4, there are shown two different configurations of the electrowetting lens 26. Operation of the electrowetting lens 26 will be described below.

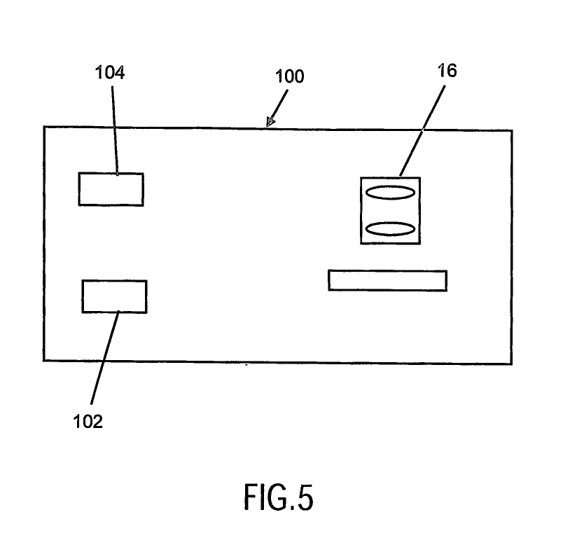

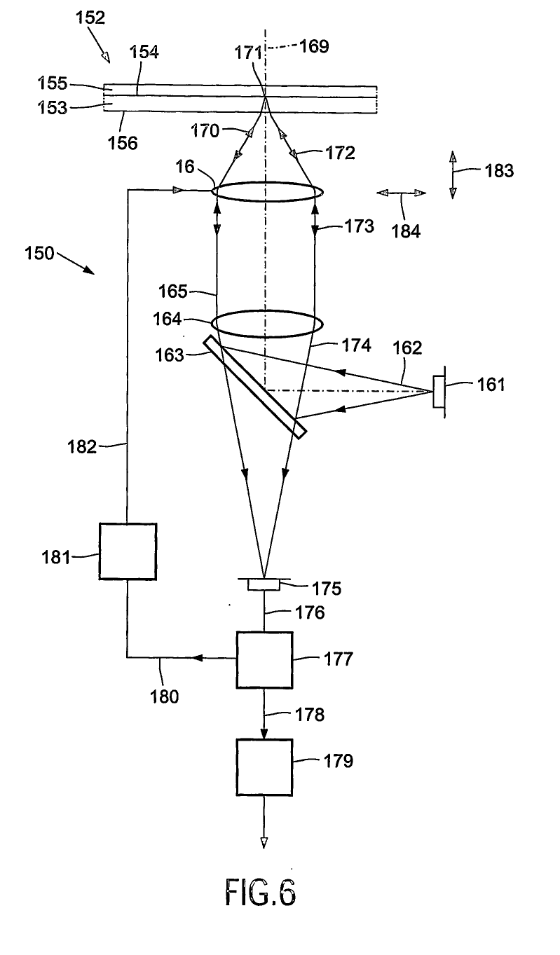

With reference to FIG. 5 of the drawings that follow, there is shown a DVD/BD player/recorder apparatus 100 comprising an optical system including an objective lens 16 as described above. The DVD/BD player/recorder apparatus 100 can operate in a DVD or a BD mode and according to its mode of operation the objective lens 16 is configured in a first state as shown in FIG. 3 for a BD or in a second state as shown in FIG. 4 for a DVD. In the latter case of FIG. 4, the focus point (hence the paraxial focal point in absence of the disk) with respect to the exit surface of the second lens is moved by more than 0.3 mm to accommodate the different cover layer thickness. The apparatus 100 comprises a detector 102 for determining whether the disk in the apparatus is a BD disk or a DVD and a controller 104 for switching between the states of the electrowetting lens 26 according to that determination.

As can be seen from a comparison between FIGS. 3 and 4, in the first state of FIG. 3, the movable stop 30 permits a wide light beam to enter the objective lens 16 and when the electrowetting lens 26 is in the second state of FIG. 4, the stop 30 moves under the control of controller 104 to permit a narrower beam of light to enter the objective lens 16.

Referring to FIG. 6 of the drawings that follow, there is shown a device 150 for scanning an optical record carrier 152, including an objective lens 16 (indicated for schematic simplicity as a single lens in FIG. 6). The record carrier comprises a transparent layer 153, on one side of which an information layer 154 is arranged. The side of the information layer facing away from the transparent layer is protected from environmental influences by a protection layer 155. The side of the transparent layer facing the device is called the entrance face 156. The transparent layer 153 acts as a substrate for the record carrier by providing mechanical support for the information layer.

Alternatively, the transparent layer may have the sole function of protecting the information layer, while the mechanical support is provided by a layer on the other side of the information layer, for instance by the protection layer 155 or by a further information layer and a transparent layer connected to the information layer 154.

Information may be stored in the information layer 154 of the record carrier in the form of optically detectable marks arranged in substantially parallel, concentric or spiral tracks, not indicated in the Figure. The marks may be in any optically readable form, e.g. in the form of pits, or areas with a reflection coefficient or a direction of magnetisation different from their surroundings, or a combination of these forms.

The scanning device 150 comprises a radiation source 161 that can emit a radiation beam 162. The radiation source may be a semiconductor laser. A beam splitter 163 reflects the diverging radiation beam 162 towards a collimator lens 164, which converts the diverging beam 162 into a collimated beam 165. The collimated beam 165 is incident on the objective lens 16.

The objective lens 16 has an optical axis 169. The objective lens 16 changes the beam 167 to a converging beam 170, incident on the entrance face 156 of the record carrier 152. The converging beam 170 forms a spot 171 on the information layer 154. Radiation reflected by the information layer 154 forms a diverging beam 172, transformed into a substantially collimated beam 173 by the objective lens 16 and subsequently into a converging beam 174 by the collimator lens 164. The beam splitter 163 separates the forward and reflected beams by transmitting at least part of the converging beam 174 towards a detection system 175. The detection system captures the radiation and converts it into electrical output signals 176. A signal processor 177 converts these output signals to various other signals.

One of the signals is an information signal 178, the value of which represents information read from the information layer 154. The information signal is processed by an information processing unit for error correction 179. Other signals from the signal processor 177 are the focus error signal and radial error signal 180. The focus error signal represents the axial difference in height between the spot 171 and the information layer 154. The radial error signal represents the distance in the plane of the information layer 154 between the spot 171 and the centre of a track in the information layer to be followed by the spot. The focus error signal and the radial error signal are fed into a servo circuit 181, which converts these signals to servo control signals 182 for controlling a focus actuator and a radial actuator respectively. The actuators are not shown in the Figure. The focus actuator controls the position of the objective lens 16 in the focus direction 183, thereby controlling the actual position of the spot 171 such that it coincides substantially with the plane of the information layer 154. The radial actuator controls the position of the objective lens 168 in a radial direction 184, thereby controlling the radial position of the spot 171 such that it coincides substantially with the central line of track to be followed in the information layer 154. The tracks in the Figure run in a direction perpendicular to the plane of the Figure.

By switching the electrowetting lens 26 from a first state to a second state it is possible to change the conjugate distance at which the second lens 24 operates. Thus the distance between the focus point of the objective lens 16 and the exit surface of the second lens 24 can be increased. Thus it is possible to use an objective lens according to a preferred embodiment of the present invention to prevent a significant reduction pf the free working distance when focussing on a DVD.

A preferred embodiment of the present invention uses an oil and water combination as the two fluids for the electrowetting lens. The refractive index of the oil is chosen to be 1.6 in both readout modes. The refractive index of water is 1.349 for the BD readout mode and 1.331 for the DVD readout mode.

In the first state of the electrowetting lens 26 of FIG. 3 for a BD disk, the interface between the oil and water is flat. The numerical aperture is 0.85 and the cover layer on the BD is 0.1 mm thick with a refractive index of 1.622. The free working distance is 0.108 mm in this configuration.

In the second (different) state of the electrowetting lens of FIG. 4 for a DVD, the numerical aperture is 0.6 and cover layer 0.6 mm having a refractive index of 1.580. The oil/water interface is curved with a radius of 2.068 mm. The free working distance is 0.13 mm.

The wave front aberration in the BD case is 8 mλ and in the DVD case is 13 mλ. As the change in optical power of the electrowetting lens 26 and the conjugate change in the second lens 24 both introduce spherical aberration, the objective lens 16 can be tuned to compensate for these to substantially reduce any resultant spherical aberration.

Although in the most preferred embodiment of the present invention, an electrowetting lens is used, it is also possible to use other variable lenses formed by the interface between two immiscible fluids.

For instance, a lens of the type described in [Philips ID PHNL 030467EPP] can be used in which a chamber holds a first fluid and a second fluid in contact over a meniscus extending transverse of an optical axis, the perimeter of the meniscus being constrained by side walls. The fluids are immiscible and have different indices of refraction. A pump is provided to controllably alter the position of the meniscus along the optical axis by altering the relative volume of each of the fluids in the chamber. This provides a translatable meniscus.

Alternatively, a lens as described in [Philips ID PHNL 030434EPP] can be used. In this alternative a structure similar to that described in the preceding paragraph is used, except that the perimeter of the meniscus between the two fluids is fixed so that the action of the pump controllably alters the shape of the meniscus. This provides a deformable meniscus.

It will be appreciated that although embodiments of the present invention have been described in relation to a BD/DVD embodiment, the objective lens described is suitable for use with any disk combination of differing thicknesses, and in particular of differing cover thickness. For instance, it is possible to make a BD objective lens compatible with a Compact Disk (CD) readout. Furthermore, although here the case of two different readout modes is discussed (BD/DVD), the invention can also be used for more than two readout modes for instance to make a BD/DVD/CD compatible system.

In its broadest aspect, the present invention is not restricted to two element objective lenses and can find application in single as well as multiple element objective lenses.

Although referred to as a “disk”, the optical record carriers described herein can be of any shape.

Furthermore, embodiments of the present invention can find application in image capture devices and optical scanning devices.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An optical device comprising an objective lens according to any one of claims 5-23.

2. An optical scanning device for scanning an optical disk, the optical scanning device comprising an objective lens according to any one of claims 5-23.

3. An optical disk reproducing/recording apparatus comprising an objective lens according to any one of claims 5-23.

4. An optical disk reproducing/recording apparatus according to claim 3, in which the apparatus has DVD and BD modes and further comprises a controller for switching between the DVD and BD modes, whereby in the DVD mode the variable lens is in a first state for a DVD and in the BD mode the variable lens is in a second state for a BD.

5. An objective lens, which objective lens comprises a variable lens formed by the interface between two immiscible fluids, which variable lens can be in one of at least two different states and whereby the focus point of the objective lens varies between the two states of the variable lens.

6. An objective lens according to claim 5, in which the focus point varies by at least 0.1 mm.

7. An objective lens according to claim 5 or claim 6, in which the focus point varies by at least 0.25 mm.

8. An objective lens according to any one of claims 5-7, in which the focus point varies by at least 0.45 mm.

9. An objective lens according to any one of claims 5-8, in which the focus point varies by 0.5 mm.

10. An objective lens according to any one of claims 5-9, in which in the first state of the variable lens the objective lens is configured for use with a disk having a first cover layer thickness and in the second state the objective lens is configured for use with a disk having a different cover layer thickness.

11. An objective lens according to any one of claims 5-10, the objective lens is configured whereby a change in state of the variable lens between a configuration for a first disk of a first cover layer thickness and a second disk of a second cover layer thickness compensates for the introduction of spherical aberration introduced by differences between the first and second disks.

12. An objective lens according to any one of claims 6-12, in which the objective lens is suitable for a combined BD and DVD system.

13. An objective lens according to any one of claims 5-12, in which the variable lens comprises a first fluid and a second fluid, and the first and second fluids are of substantially identical specific gravity.

14. An objective lens according to any one of claims 5-12, in which a first fluid comprises a substantially non-conductive fluid, further referred to as an oil, whilst a second fluid comprises a substantially conducting and/or polar fluid, further referred to as an electrolyte.

15. An objective lens according to any one of claims 5-13, in which a second fluid comprises a water/salt mixture having a refractive index different to the refractive index of a first fluid.

16. An objective lens according to any one of claims 5-15, in which the objective lens comprises a first lens and a second lens, in which the first lens precedes the second lens in an optical path from a light source to a disk.

17. An objective lens according to claim 16, in which the first lens is a converging lens.

18. An objective lens according to any one of claims 5-17, in which the objective lens further comprises a movable stop to change the aperture size of the objective lens between the two states of the variable lens.

19. An objective lens according to any one of claims 5-18, in which the objective lens comprises a two lens objective lens.

20. An objective lens according to any one of claims 5-19, in which the variable lens comprises an electrowetting lens.

21. An objective lens according to claim 20, in which the electrowetting lens comprises a transparent first element, a transparent second element, a cavity formed between the transparent first element and the transparent second element, first and second immiscible fluids of differing refractive index contained within the cavity, and electrodes to which a potential difference can be applied to change a contact angle between an interface layer of the two fluids and a wall of the cavity.

22. An objective lens according to claim 21, in which the first wall comprises a first lens of the objective lens.

23. An objective lens according to claim 21 or claim 22, in which the second wall is spaced from a second lens.
